(19) United States
(12) Patent Application Publication
(10) Pub. No.: US 2026/0027801 A1
(43) Pub. Date: Jan. 29, 2026

(54) MULTILAYER TEXTILE ASSEMBLY COMPRISING MINERAL REINFORCEMENT FIBERS

(71) Applicants: AIRBUS HELICOPTERS, Marignane Cedex (FR); ISOMATEX, Gembloux (BE)

(72) Inventors: Tigran VARTANIAN, Gembloux (BE); Edwin HENRY, Gembloux (BE); Bernard VOSS, Gembloux (BE)

(73) Assignees: AIRBUS HELICOPTERS, Marignane Cedex (FR); ISOMATEX, Gembloux (BE)

(21) Appl. No.: 19/207,600

(22) Filed: May 14, 2025

(30) Foreign Application Priority Data
Jul. 26, 2024 (EP) 24315360.8

(51) Int. Cl. B32B 5/26; B32B 5/02; D03D 13/00

(52) U.S. Cl. CPC B32B 5/275; B32B 5/024; D03D 13/004; B32B 2250/04; B32B 2250/05; B32B 2255/02; B32B 2262/10; B32B 2307/718; B32B 2605/00; D10B 2101/02; D10B 2401/00; D10B 2505/12

(57) ABSTRACT

A multilayer textile assembly. This textile assembly comprises an outer layer and a base layer on either side of a core, the core comprising at least one sub-assembly, each sub-assembly of the at least one sub-assembly comprising a woven inner layer and a felt layer, the inner layer being disposed between the felt layer and the outer layer, the outer layer as well as the base layer and the inner layer comprising continuous, sized, mineral reinforcement fibers, the felt layer comprising discontinuous, sized, mineral reinforcement fibers.

### CROSS REFERENCE TO RELATED APPLICATION

This application claims priority to European Patent Application No. EP 24315360.8 filed on Jul. 26, 2024, the disclosure of which is incorporated in its entirety by reference herein.

### TECHNICAL FIELD

The present disclosure relates to a multilayer textile assembly comprising mineral reinforcement fibers, as well as to a composite structural component comprising such a textile assembly and to a vehicle comprising such a composite structural component.

### BACKGROUND

A composite structural component may comprise a plurality of layers.

For example, a composite structural component may comprise a plurality of layers stacked one on top of the other. Each layer may therefore be, for example, a fabric-type or felt-type textile layer.

Some composite structural components, particularly in aircraft, are subjected to conditions of use that can damage them. For example, a composite structural component may be exposed to high temperatures, aggressive fluids (fuel/oxidant, engine oils/lubricants, engine rinses, detergents), thermo-oxidative ageing, impacts, and the risk of fire and corrosion.

In particular, an aircraft bulkhead delimiting an engine compartment housing a combustion engine is subject to high temperatures and fluid splashes, and may be required to withstand a fire for a minimum period. Similarly, a wall delimiting a volume housing one or more electrical batteries is subject to a risk of fire.

In addition, a conventional composite structural component may comprise chemical binders. For example, a conventional composite structural component may comprise layers of glass fibers bonded together by chemical binders. Such chemical binders are likely to release harmful or even flammable vapors when exposed to fire or heat.

Finally, the mass of a composite structural component is also a property to be taken into account in a vehicle, and even more so in an aircraft.

As a result, it can be difficult to produce a composite structural component with optimized mechanical, chemical, heat and fire resistance.

Documents EP 3 209 495 A1, DE 10 2022 116220 A1 and US 2021/301436 A1 are known.

### SUMMARY

The present disclosure is therefore aimed at a multilayer textile assembly comprising a stack of textile layers.

This textile assembly comprises an outer layer and a base layer on either side of a core, said core comprising at least one sub-assembly, each sub-assembly of said at least one sub-assembly comprising a woven inner layer and a felt layer, the inner layer being disposed between the felt layer and the outer layer, the outer layer as well as the base layer and the inner layer comprising mineral reinforcement fibers that are continuous and sized, the felt layer comprising mineral reinforcement fibers that are discontinuous and sized.

The expression “the inner layer being disposed between the felt layer and the outer layer” means that the inner layer of a particular sub-assembly is disposed between the felt layer of that sub-assembly and the outer layer in a direction from the base layer to the outer layer, the inner layer of that particular sub-assembly being able to be disposed against the outer layer or felt layer of another sub-assembly where appropriate.

The textile assembly can form a mat. Such a mat then forms a sub-product that may form an integral part of a composite structural component. Alternatively, the various layers may form sub-products assembled during the manufacture of the composite structural component.

The various layers can be bonded together mechanically using at least one heat-resistant and flame-resistant stitching yarn, and/or chemically using a flame-retardant and/or intumescent adhesive.

The mineral reinforcement fibers have properties that enable them to withstand extreme conditions, in particular high temperatures and fire.

In addition, the base layer, outer layer and one or more inner layers form woven layers that act as a thermal shield and as a mechanical reinforcement for the textile assembly. These woven layers enable the textile assembly to maintain its integrity during use.

In addition, the one or more felt layers form non-woven layers that provide a thermally insulating thickness between the outer layer, exposed to heat or fire, and the opposite base layer in contact with the elements to be protected of the composite structural component.

Moreover, the sequence wherein the various layers are stacked in relation to one another determines the thermal insulation effect obtained between the base layer and the outer layer, as well as the attenuation of heat flow through the textile, fire protection assembly. This arrangement tends to limit denaturation and thermo-oxidative deterioration of layers following exposure of the outer layer to flame.

The composition of the layers in the textile assembly and the precise order wherein the layers are stacked thus enable a synergy to produce a textile assembly that is mechanically and chemically resistant, as well as resistant to heat and fire. Such a textile assembly can thus be incorporated into a composite structural component in order to form optimum protection against thermal ageing, as well as against the propagation through the textile assembly of a fire, gas or hot fluid. In this way, the woven and felt layers based on mineral reinforcement fibers and their arrangements in relation to each other make it possible to obtain a textile assembly that is mechanically resistant, and resistant to at least heat and fire.

This textile assembly may also comprise one or more of the following features.

According to one possibility, each woven layer may comprise a unidirectional or multidirectional fabric.

According to one possibility compatible with the preceding possibilities, the outer layer as well as the inner layer and the base layer each have a coverage rate greater than 95%.

The coverage rate tx is equal to a surface area S1 covered by the mineral reinforcement fibers, divided by the total surface area S2 of the layer concerned, multiplied by 100, i.e., tx=(S1/S2)*100.

Such a coverage rate means that the gaps in the textile assembly are limited. As a result, this property gives the assembly increased effectiveness in terms of its barrier effect against fire (oxidation, melting), heat and splashes/passage of fluids (fuel/oxidant, engine oils/lubricant, engine rinsing products, detergents, aggressive outdoor environment, etc.).

According to one possibility compatible with the preceding possibilities, the outer layer as well as the inner layer and the base layer may comprise fabrics having a taffeta-type weave.

A taffeta-type weave is effective for optimum barrier effect.

According to one possibility compatible with the preceding possibilities, the outer layer as well as the inner layer and the base layer each have a mass per unit area of between 10 g/m² and 1500 g/m², preferably between 200 g/m² and 800 g/m².

The more densely woven or thicker a woven layer is, the more this woven layer absorbs and/or diffuses heat within it. A woven layer therefore protects the one or more layers opposite the source of fire or heat more effectively, by reducing the heat flux transmitted.

The mass per unit area of the outer layer, the one or more inner layers and the base layer are maximized and adjusted according to the thickness and mass required for the textile assembly.

By way of example, the use of a layer woven with taffeta weave and having the above-mentioned mass per unit area makes it possible to obtain a textile assembly that is mechanically resistant to heat and fire, while having a thickness that gives the textile assembly an optimized mass enabling its use in aeronautic applications.

According to one possibility compatible with the preceding possibilities, the felt layer has a mass per unit area of between 10 g/m² and 1500 g/m², preferably between 200 g/m² and 1200 g/m².

The thicker the non-woven layer, the greater the temperature difference on either side of this layer. However, the thicker the layer, the heavier this non-woven layer will be. The density of a non-woven layer, i.e., the distribution of fibers and cavities/air cells in a given volume of this layer, influences its thermal conductivity coefficient lambda, and therefore the thermal resistance R of the non-woven layer. Indeed, the thermal resistance R is equal to the quotient e/lambda where e is the thickness of the non-woven layer and lambda represents the thermal conductivity coefficient of this layer.

To achieve an acceptable compromise, the non-woven layer can therefore have a mass per unit area of between 10 g/m² and 1500 g/m², ideally between 200 g/m² and 1200 g/m². The mass per unit area can be adjusted according to the desired thickness and mass.

According to one possibility compatible with the preceding possibilities, the outer layer is provided with a protective outer coating.

This protective outer coating may comprise an aluminum oxide, in particular the coating known to a person skilled in the art as ALOx. The protective outer coating may extend into the thickness of the outer layer, or over an outer face facing the outside environment, or over an inner face facing the core of the textile assembly. Positioning on the outer face is particularly advantageous.

According to one possibility compatible with the preceding possibilities, the inner layer is equipped with a protective inner coating.

This protective inner coating may comprise an aluminum oxide, in particular the ALOx coating. The protective inner coating of an inner layer of a sub-assembly may extend into the thickness of the inner layer, or over a front face facing the outer layer or over a rear face facing the felt of the sub-assembly. Positioning on the front face is particularly advantageous.

It is in fact possible to provide one or more woven layers with protective coatings, in particular for the outer layer and one or more inner layers, or even for the base layer. A heat-resistant ceramic (geopolymer) coating can be incorporated into a woven layer to reinforce and improve its protection against oxidation and heat, for example by infrared reflection. Such a protective coating also enables the structure of the woven layer to be maintained throughout its lifetime, and contributes to maintaining better mechanical integrity of this layer after prolonged exposure to flame, without fire initiation and propagation. The method of depositing such a coating on the surface or impregnating it into the thickness of a woven layer also enables it to act as a gas-tight barrier.

According to one example, said at least one sub-assembly comprises a surface sub-assembly provided with an inner layer having said protective inner coating bonded to the outer layer, this outer layer being provided with said protective outer coating, the felt layer of this surface sub-assembly being bonded to an inner layer of another sub-assembly or to the base layer.

In the presence of a plurality of sub-assemblies, it is possible that only the inner layer of the sub-assembly adjoining the outer layer comprises a protective inner coating, or a plurality of inner layers may have such a protective inner coating.

According to one possibility compatible with the preceding possibilities, said mineral reinforcement fibers may comprise a mixture of minerals, said mixture of minerals optionally originating from volcanic rocks, said mixture of minerals comprising basalt.

Such mineral reinforcement fibers can be obtained from a mixture of minerals from volcanic rocks, including in particular basalt (including derivatives of this family, such as andesite, gabbro, etc.) and additional minerals.

The various layers of the textile assembly may then, for example, comprise mineral reinforcement fibers known under the brand name FILAVA®.

The mixture can be obtained from crushed volcanic rocks containing basalt and powders or mineral fractions of other minerals. Basalt inherently exhibits a certain volatility across the planet. The use of a mixture of minerals enables a homogeneous, stable and reproducible mixture to be obtained, with high mechanical properties, as well as thermal and chemical resistances that can lead to the production of a textile assembly that performs well mechanically and when used in hot areas subject to the risk of fire.

Moreover, such volcanic rock-based fibers, enriched with other minerals, may not react with air or water generating toxic products, and are non-combustible (no release of fumes) and are explosion-proof. When in contact with other chemicals, such volcanic rock-based fibers enriched with other minerals may be inert and produce no chemical reaction.

The minerals may have a silica content of less than 65 mass % (65% m).

The symbol mass& refers to a percentage by mass.

Such a silica content makes it possible, during the manufacture of mineral reinforcement fibers, to obtain a molten magma enabling the manufacture of fine continuous fibers. If this is not the case, the molten magma is very viscous, which can prevent it from flowing into the devices used to generate the mineral reinforcement fibers.

Optionally, the minerals may have more than 80 mass % acidic oxides.

The advantage of such a feature is that they can be processed to a greater extent, in particular to produce fine fibers.

According to one possibility, compatible with the preceding possibilities, said mineral reinforcement fibers comprise a mixture of silicon oxides and additional metal oxides.

The mixture can be obtained from very widely used basalt.

According to one possibility compatible with the preceding possibilities, the additional metal oxides comprise a percentage by mass of aluminum oxides of between 45 mass % and 55 mass %, a percentage by mass of alkaline earth mineral oxides less than 30 mass %, a percentage by mass of iron oxides of between 9.5 mass % and 10.5 mass %.

Such a mixture makes it possible to obtain mineral reinforcement fibers that are mechanically and chemically resistant, as well as heat and fire resistant.

According to one possibility compatible with the preceding possibilities, said mineral reinforcement fibers may have an acidity index greater than approximately 5.5.

This acidity index is equal to the sum of the masses of acidic oxides divided by the sum of the masses of basic oxides.

With such an acidity index, it is possible to obtain, from the mixture of minerals, a molten lava with a viscosity enabling the manufacture of mineral reinforcement fibers for textiles in the usual way.

According to one possibility compatible with the preceding possibilities, said mineral reinforcement fibers can have a softening temperature greater than a threshold of between 800° C. and 900° C., and a melting point greater than 1150° C.

These properties provide excellent thermal resistance for mineral reinforcement fibers.

According to one possibility compatible with the preceding possibilities, the mineral reinforcement fibers of the outer layer as well as of the inner layer and of the base layer are sized differently from the felt layer.

The mineral reinforcement fibers of the woven and felt layers may comprise the same mixture of minerals but, by contrast, may be sized differently. The mineral reinforcement fibers of the outer layer as well as of the inner layer and of the base layer are sized differently from the felt layer. Protective and sizing primers can be applied in the usual manner.

The mineral reinforcement fibers of the woven layers may comprise a specific sizing, compatible with a textile-plastic, textile or other transformation process to make them compatible with an optional protective coating and/or with a potential adhesive. The mineral reinforcement fibers of the felt layers may comprise a specific sizing compatible with a textile-plastic, textile or other transformation process to obtain good opening in order to achieve an optimum density to thickness ratio enabling a maximized thermal resistance R to be imparted to the textile assembly.

According to another aspect, the disclosure also relates to a composite structural component. This composite structural component comprises a body bonded to the base layer of a textile assembly according to the disclosure.

Furthermore, a vehicle, for example an aircraft, or even a rotorcraft in particular, can also include such a composite structural component.

### BRIEF DESCRIPTION OF THE DRAWINGS

The disclosure and its advantages appear in greater detail from the following description of examples given by way of illustration with reference to the accompanying figures, wherein:

FIG. 1, shows an exploded view of a textile assembly according to the disclosure;

FIG. 2, shows a view of a woven layer according to the disclosure;

FIG. 3, shows a view of a felt layer;

FIG. 4, shows an exploded view of a textile assembly according to the disclosure;

FIG. 5, shows an exploded view of a textile assembly according to the disclosure;

FIG. 6, shows a view of a composite structural component of a textile assembly according to the disclosure; and

FIG. 7, shows a partial view of a vehicle fitted with such a composite structural component.

### DETAILED DESCRIPTION

Elements present in more than one of the figures are given the same references in each of them.

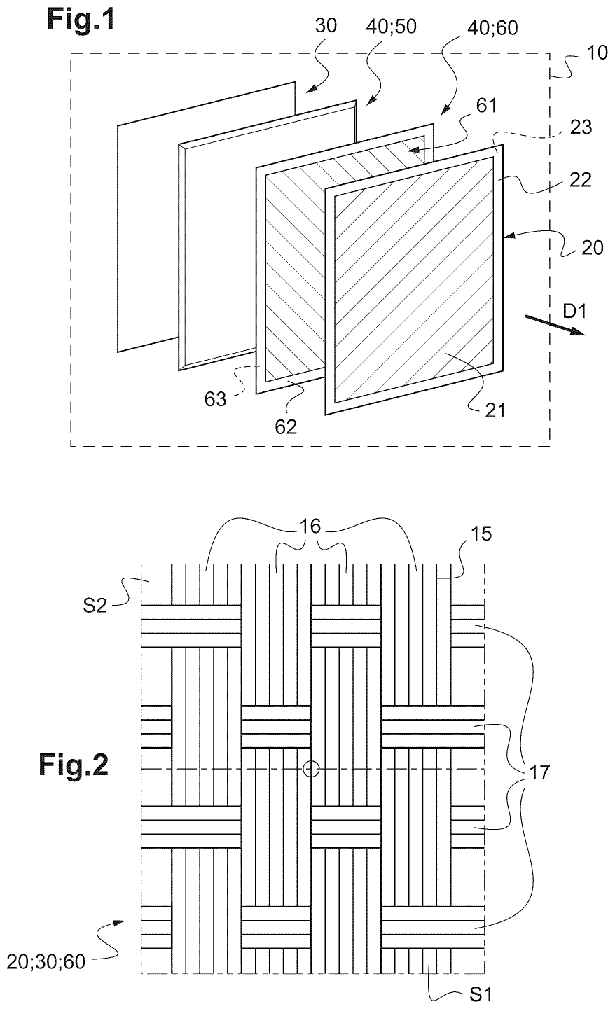

FIG. 1 shows an example of a multilayer textile assembly 10 according to the disclosure.

Whatever the embodiment, such a textile assembly 10 comprises a stack of textile layers. The various textile layers can be assembled with a mechanical and/or chemical binder.

In particular, the textile assembly 10 comprises an outer layer 20 and a base layer 30 that are arranged on either side of a core 40 in a direction known as the “thickness direction D1” for convenience.

The thickness direction D1 extends from the base layer 30 to the outer layer 20. The term “thickness” associated with a layer refers to the dimension of the layer along the thickness direction D1. Conversely, the term “surface” refers to an area of a face perpendicular to this thickness direction D1.

In addition, the core 40 comprises one or more sub-assemblies. Whatever the number of sub-assemblies, the sub-assembly or sub-assemblies each comprise a woven inner layer 60 and a felt layer 50. The woven inner layer 60 is adjacent to and/or abutting the felt layer 50. The inner layer 60 is positioned between the felt layer 50 and the outer layer 20 in the thickness direction D1.

FIGS. 1, 4 and 5 illustrate examples with a single sub-assembly, but the textile assembly 10 may alternatively comprise at least two sub-assemblies.

FIG. 2 illustrates a woven layer that can be the outer layer 20, the base layer 30 or an inner layer 60.

With reference to FIG. 2, the outer layer 20, as well as the base layer 30 and the one or more inner layers 60, comprise mineral reinforcement fibers 15 that are sized and continuous.

In addition, the outer layer 20 as well as the base layer 30 and the inner layer 60 can each have a coverage rate greater than 95%. In other words, for each woven layer 20, 30, 60, the quotient of the area S1 covered by the mineral reinforcement fibers 15 of this woven layer 20, 30, 60 and the area S2 covered by this woven layer 20, 30, 60 in question, is greater than 0.95. The outer layer 20 as well as the base layer 30 and the one or more inner layers 60 each have very few internal spaces, that maximizes their ability to act as a barrier to a flow of heat, a flame or various splashes.

Optionally, the outer layer 20, as well as the base layer 30 and the one or more inner layers 60 may each have a mass per unit area of between 10 g/m² and 1500 g/m², preferably between 200 g/m² and 800 g/m².

The mineral reinforcement fibers 15 can form a unidirectional or multidirectional textile.

According to the example illustrated, at least one of the outer layer 20, the base layer 30 and the inner layer 60 may take the form of a fabric having a taffeta-type weave. Such a fabric comprises mineral reinforcement fibers 16 disposed in a weft direction and mineral reinforcement fibers 17 disposed in a warp direction. Each warp fiber passes alternately above and below each weft fiber, and vice versa. This type of weave makes it possible to achieve a high degree of coverage and fiber density.

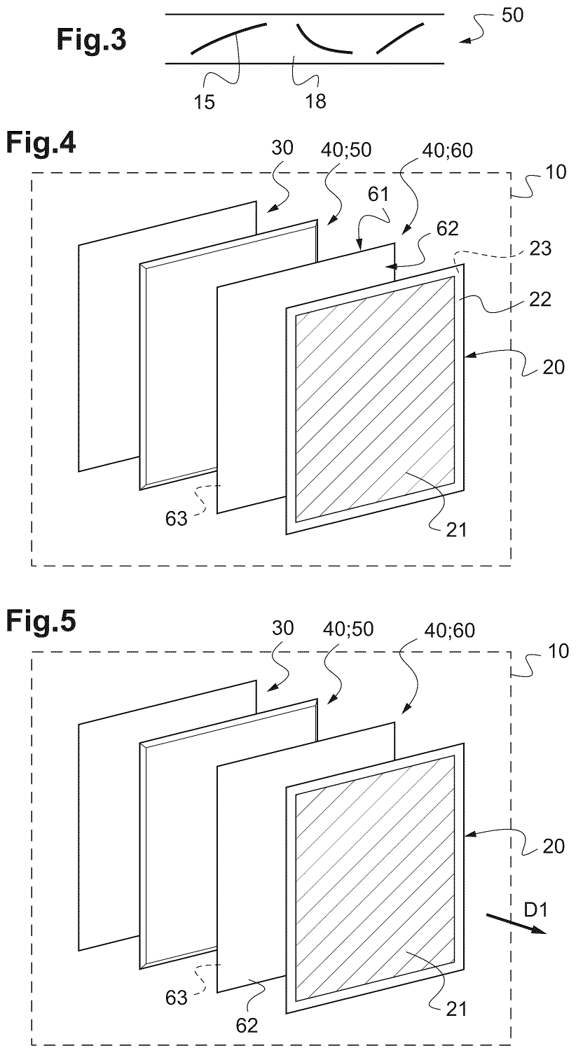

With reference to FIG. 3, the one or more felt layers 50 comprise mineral reinforcement fibers 15, that are sized but discontinuous. The mineral reinforcement fibers 15 are disposed in a matrix 18.

Optionally, the felt layer 50 has a mass per unit area of between 10 g/m² and 1500 g/m², preferably between 200 g/m² and 1200 g/m².

The mineral reinforcement fibers 15 used in the various layers 20, 30, 40, 50, 60 are of the same type, or even identical.

These mineral reinforcement fibers 15 may comprise a mixture of minerals, said mixture of minerals comprising basalt that may come from volcanic rocks.

For example, minerals with a silica content of less than 65 mass % and/or more than 80 mass % acidic oxides

Optionally, the mineral reinforcement fibers 15 comprise a mixture of silicon oxides and additional metal oxides. The additional metal oxides may have the following composition: a percentage by mass of aluminum oxides of between 45 mass % and 55 mass %, a percentage by mass of alkaline earth mineral oxides less than 30 mass %, a percentage by mass of iron oxides of between 9.5 mass % and 10.5 mass %.

Optionally, said mineral reinforcement fibers have an acidity index greater than approximately 5.5.

Furthermore, the mineral reinforcement fibers 15 have a softening temperature greater than a threshold of between 800° C. and 900° C., and a melting point greater than 1150° C.

Although the mineral reinforcement fibers 15 are of the same type, the mineral reinforcement fibers 15 of the outer layer 20 as well as of the inner layer 60 and of the base layer 30 are possibly sized differently from the felt layer 50. The sizing is chosen in the usual way, for example, as a function of the elements, adhesives or coatings, if any, disposed against the various layers.

With reference to FIG. 1, at least one woven layer 20, 30, 60 may be provided with a protective coating.

Thus, the outer layer 20 can be provided with a protective outer coating 21. This protective outer coating 21 can be disposed on the outer face 22 of the outer layer 20 facing an external medium, or on the inner face 23 of the outer layer 30 disposed against the core 40, or within the outer layer 20.

One or more inner layers 60 may be provided with a protective inner coating 61. Such a protective inner coating 61 may be disposed on the front face 62 of the inner layer 60 disposed against another sub-assembly or the outer layer 20, or on the rear face 63 of the inner layer 60 disposed against the felt layer of the same sub-assembly, or within the inner layer 60. Optionally, a base layer may also comprise such a coating.

According to the examples shown in FIGS. 1 and 4, the textile assembly comprises a surface sub-assembly provided with an inner layer 60 having said protective inner coating 61 bonded to the outer layer 20, this outer layer 20 being provided with said protective outer coating 21, the felt layer 50 of this surface sub-assembly being bonded to the base layer 30 but being able to be bonded alternatively to another sub-assembly.

In particular, the example shown in FIG. 1 comprises an outer protective coating 21 on the outer face 22 of the outer layer 20, and an inner protective coating 61 on the front face 62 of the outer layer 20.

By way of illustration, such a textile assembly 10 with a thickness of 10.3 mm, with woven layers 20, 30, 60 having a mass per unit area of 200 g/m² and a felt layer 50 having a mass per unit area of 800 g/m², was successfully exposed for 15 minutes to a flame of approximately 1300° C.-1500° C. located 7-8 cm from the outer layer 20. The flame did not penetrate the textile assembly 10 and no release of smoke was observed. The outer face 22 of the outer layer 20 exposed to the flame exhibited temperatures of order 1100-1170° C. while the opposite face in the base layer 30 exhibited a temperature of order 130-300° C.

The example shown in FIG. 4 comprises an outer protective coating 21 on the outer face 22 of the outer layer 20, and an inner protective coating 61 not on the front face 62 but on its rear face 63.

By way of illustration, such a textile assembly 10 with a thickness of 10.3 mm, with woven layers 20, 30, 60 having a mass per unit area of 200 g/m² and a felt layer 50 having a mass per unit area of 800 g/m², was successfully exposed for 15 minutes to a flame of approximately 1300° C.-1500° C. located 7-8 cm from the outer layer 20. The flame has not passed through the textile assembly 10. The outer face 22 of the outer layer 20 exposed to the flame exhibited temperatures of order 1060-1150° C. while the opposite face in the base layer 30 exhibited a temperature of order 160-300° C.

In the example shown in FIG. 5, the inner layer 60 has no protective coating.

By way of illustration, such a textile assembly 10 with a thickness of 10.3 mm, with woven layers 20, 30, 60 having a mass per unit area of 200 g/m² and a felt layer 50 having a mass per unit area of 800 g/m², was successfully exposed for 15 minutes to a flame of approximately 1300° C.-1500° C. located 7-8 cm from the outer layer 20. The flame has not passed through the textile assembly 10. The outer face 22 of the outer layer 20 exposed to the flame exhibited temperatures of order 1090-1130° C. while the opposite face in the base layer 30 exhibited a temperature of order 240-300° C.

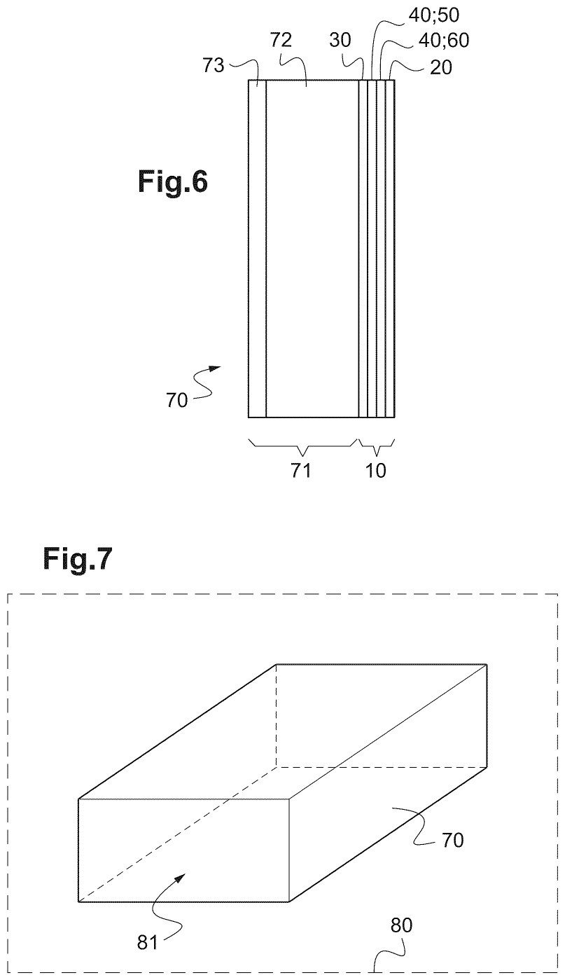

With reference to FIG. 6, a textile assembly 10 according to the disclosure may be a constituent part of a composite structural component 70. The textile assembly 10 may take the form of a mat assembled prior to its arrangement within the composite structural component 70. Alternatively, the various layers of the textile assembly 10 have been assembled during manufacture of the composite structural component 70.

This composite structural component 70 therefore comprises a body 71 secured to the base layer 30 of the textile assembly 10. By way of example, the body 71 may comprise a core 72 secured to the base layer 30 and to a skin 73, the core 72 extending from the skin 73 to the base layer 30.

FIG. 7 illustrates a vehicle 80. This vehicle 80 comprises such a composite structural component 70, for example to delimit an area 81 presenting a risk of fire or high temperatures, of the order of several hundred degrees Celsius, for example.

Naturally, the present disclosure may be subjected to numerous variations as to its implementation. Although several embodiments are described above, it should readily be understood that it is not conceivable to identify exhaustively all the possible embodiments. It is of course possible to replace any of the means described with equivalent means without going beyond the ambit of the present disclosure.

What is claimed is:

1. A multilayer textile assembly comprising a stack of textile layers,
wherein the textile assembly comprises an outer layer and a base layer on either side of a core, the core comprising at least one sub-assembly, each sub-assembly of the at least one sub-assembly comprising an inner layer the is woven and a felt layer, the inner layer being disposed between the felt layer and the outer layer, the outer layer as well as the base layer and the inner layer comprising mineral reinforcement fibers that are continuous and sized, the felt layer comprising mineral reinforcement fibers that are discontinuous and sized.

2. The textile assembly according to claim 1,
wherein the outer layer as well as the inner layer and the base layer each have a coverage rate greater than 95%.

3. The textile assembly according to claim 1,
wherein the outer layer as well as the inner layer and the base layer comprise fabrics having a taffeta-type weave.

4. The textile assembly according to claim 1,
wherein the outer layer as well as the inner layer and the base layer each have a mass per unit area of between 10 g/m² and 1500 g/m², preferably between 200 g/m² and 800 g/m².

5. The textile assembly according to claim 1,
wherein the felt layer has a mass per unit area of between 10 g/m² and 1500 g/m², preferably between 200 g/m² and 1200 g/m².

6. The textile assembly according to claim 1,
wherein the outer layer is provided with a protective outer coating.

7. The textile assembly according to claim 1,
wherein the inner layer is provided with a protective inner coating.

8. The textile assembly according to claim 6, wherein the inner layer is provided with a protective inner coating and wherein the at least one sub-assembly comprises a surface sub-assembly provided with an inner layer having the protective inner coating bonded to the outer layer, this outer layer being provided with the protective outer coating, the felt layer of this surface sub-assembly being bonded to an inner layer of another sub-assembly or to the base layer.

9. The textile assembly according to claim 1,
wherein the mineral reinforcement fibers comprise a mixture of minerals, the mixture of minerals comprising basalt.

10. The textile assembly according to claim 9,
wherein the minerals have a silica content less than 65 mass %.

11. The textile assembly according to claim 9,
wherein the minerals have more than 80 mass % acidic oxides.

12. The textile assembly according to claim 1,
wherein the mineral reinforcement fibers comprise a mixture of silicon oxides and additional metal oxides.

13. The textile assembly according to claim 12,
wherein the additional metal oxides comprise a percentage by mass of aluminum oxides of between 45 mass % and 55 mass %, a percentage by mass of alkaline earth mineral oxides less than 30 mass %, a percentage by mass of iron oxides of between 9.5 mass % and 10.5 mass %.

14. The textile assembly according to claim 1,
wherein the mineral reinforcement fibers have an acidity index greater than approximately 5.5.

15. The textile assembly according to claim 1,
wherein the mineral reinforcement fibers have a softening temperature greater than a threshold of between 800° C. and 900° C., and a melting point greater than 1150° C.

16. The textile assembly according to claim 1,
wherein the mineral reinforcement fibers of the outer layer as well as of the inner layer and of the base layer are sized differently from the felt layer.

17. A composite structural component,
wherein the composite structural component comprises a body bonded to the base layer of the textile assembly according to claim 1.

18. A vehicle,
wherein the vehicle comprises the composite structural component according to claim 17.
